(19) United States
(12) Patent Application Publication
(10) Pub. No.: US 2008/0109407 A1
(43) Pub. Date: May 8, 2008

(54) METHOD AND SYSTEM FOR AN ELECTRONIC EMBEDDED BOOK INDEX

(76) Inventors: Dustin C. Kirkland, Austin, TX (US); Ameet M. Paranjape, Cedar Park, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/557,704

(22) Filed: Nov. 8, 2006

(51) Int. Cl. G06F 7/06

(52) U.S. Cl. 707/3; 707/E17.014

(57) ABSTRACT

A method for implementing an electronic embedded book index within a printed book. A device powered by one or more power cells is attached to the back cover of a hardback book. The device includes a display, an input device, a memory device, and a processor unit. The memory device contains a search utility, a graphical user interface (GUI), and a digital copy of the text of the book that is stored in a persistent fashion. A user of the book utilizes the input device to enter search criteria. The search utility interfaces with the processor unit and locates page numbers and paragraph offsets within the stored digital text that correspond to the search criteria entered by the user. The search utility displays the search results within the GUI, thereby enabling a user of the electronic embedded book index to efficiently locate information within the printed/paper form of the book.

### BACKGROUND OF THE INVENTION

1. Technical Field

The present invention relates in general to the field of books and in particular to book indexes. Still more particularly, the present invention relates to an improved method and system for an electronic embedded book index.

2. Description of the Related Art

Conventional reference books typically include an index, which is a detailed list of the information included in the book. The index of a conventional reference book is often placed at the end of the text. A reader utilizes the index to locate specific pages that contain information on the indexed subjects. An index thus increases the ease with which a user can locate information within a book.

Although reference books often contain indexes, the quality of the index is at the discretion of the publisher. Other types of books, such as fiction, typically do not contain indexes. In these cases, it is difficult for a reader to locate particular information or passages within the book. Conventional e-books require a user to have access to a PC or CDROM, which limits the flexibility of the user to utilize an e-book in different locations where a PC or CDROM may not be available (e.g., on a plane, a boat, or in the bathroom). Furthermore, electronic databases that do not utilize POSIX (Portable Operating System Interface for a uniplexed information and computing (UNIX®) system) compliant regular expressions can be difficult to navigate. The present invention thus recognizes that an improved method and system for embedding a book index within multiple types of books are needed.

### SUMMARY OF THE INVENTION

Disclosed is a method, system, and computer program product for implementing an electronic embedded book index within a printed book. A device powered by one or more power cells is attached to the back cover of a hardback book. The device includes a display, an input device, a memory device, and a processor unit. The memory device contains a search utility, a graphical user interface (GUI), and a digital copy of the text of the book that is stored in a persistent fashion. The digital copy has similar/exact page numbers and offset parameters as the paper copy of the book's content. A user of the book utilizes the input device to enter search criteria. The search utility interfaces with the processor unit and locates page numbers and paragraph offsets within the stored digital text that correspond to the search criteria entered by the user. The search utility displays the search results within the GUI, thereby enabling a user of the electronic embedded book index to efficiently locate information within the printed/paper form of the book.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 depicts a high level block diagram of an electronic embedded book index, as utilized in an embodiment of the present invention;

FIG. 2 is a high level block diagram of the components within an electronic embedded book index, according to an embodiment of the present invention; and

FIG. 3 is a high level logical flowchart of an exemplary method of utilizing an electronic embedded book index to search for text within a book, in accordance with one embodiment of the invention.

### DETAILED DESCRIPTION OF AN ILLUSTRATIVE EMBODIMENT

The present invention provides a method, system, and computer program product for implementing an electronic embedded book index.

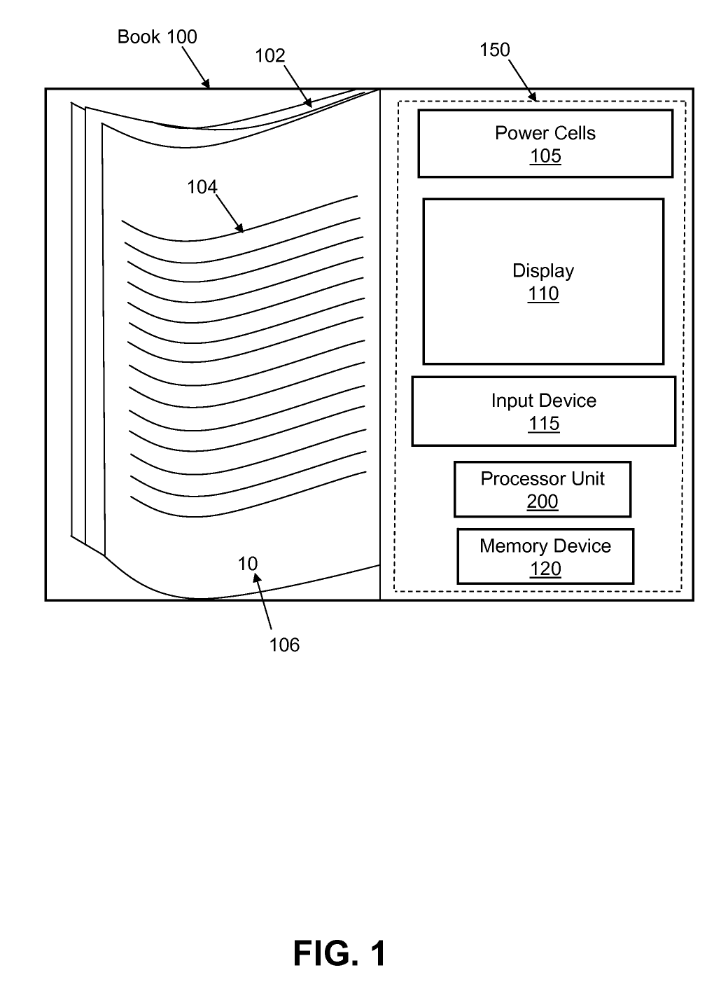

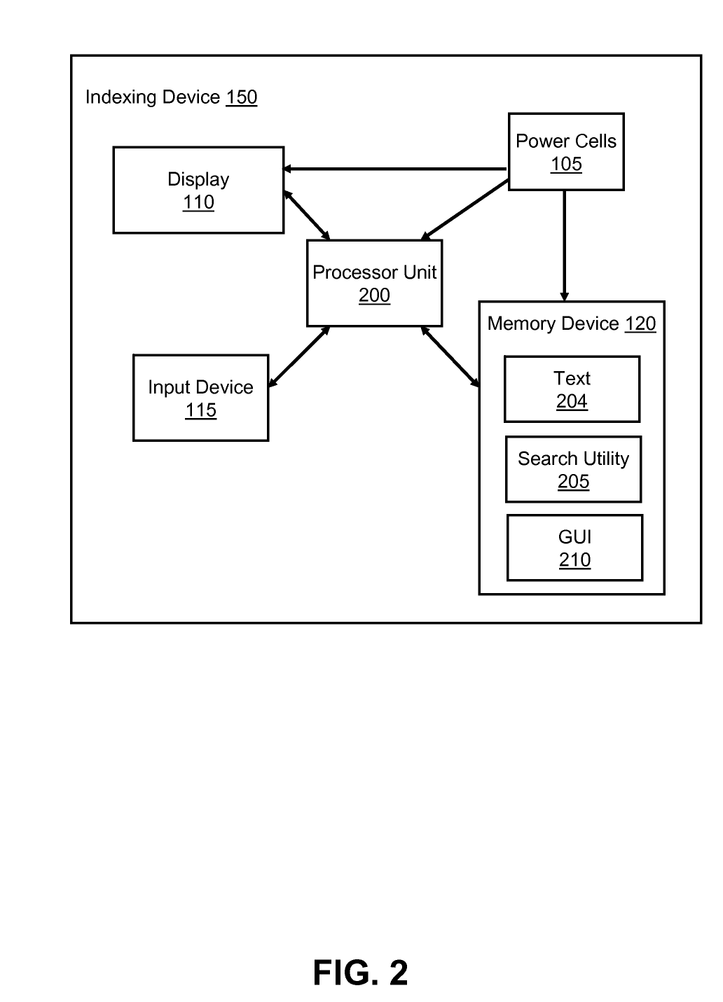

With reference now to FIG. 1, there is depicted a high level block diagram of an exemplary printed book 100 with pages 102 having textual or other content 104 thereon delineated by page numbers 106 and/or other parameters, with which the present invention can be utilized. According to the illustrative/described embodiment, book 100 is a hardback book that includes an indexing device 150, which includes one or more power cells 105, display 110, input device 115, and memory device 120, all of which fit within the confines of the back cover in the illustrative embodiment. Book 100 also includes processor unit 200, which is illustrated in FIG. 2 and discussed below.

Although FIG. 1 depicts the electronic components embedded in the back cover of book 100, in an alternate embodiment the electronic components may instead be embedded in the front cover of book 100. The electronic components may also be imbedded in both the front and back covers and interconnected via embedded wires. Similarly, the electronic components of FIG. 1 may be embedded in a clipboard, binder, or other device utilized to hold printed text. In another embodiment, indexing device 150 may be a standalone device not embedded in a book. In such an embodiment, memory device 120 may be attached to one of the covers of book 100, and may then be removed and/or connected to the standalone device to provide the electronic indexing feature during the use of the standalone device.

Power cells 105 provide electrical power to display 110, input device 115, and memory device 120. In one embodiment, power cells 105 are solar cells. In another embodiment, electrical power is provided by one or more disposable or rechargeable batteries. Electrical power can also be provided via a cable, such as a power cable or universal serial bus (USB) cable. Display 110 and input device 115 enable a user of book 100 to input index search criteria and view search results. According to the illustrative embodiment, input device 115 is a “qwerty” key pad and display 110 provides output to a user in the form of a graphical user interface (GUI), which is illustrated in FIG. 2 and discussed below. In another embodiment, input device 115 may be a touchpad that enables a user to enter data via a finger or stylus. Similarly, display 110 may provide output to a user in a text-only (i.e., non graphical) format.

Typically, with conventional compression and/or memory storage schemes the full text of a book is typically less than 1 MB (e.g., the text of The Adventures of Huckleberry Finn by Mark Twain is 705 KB). According to the illustrative embodiment, memory device 120 stores data in a persistent fashion in flash memory, which may be 1 MB, for example. Memory device 120 may be removable and/or interchangeable with a similar memory device with a storage capacity other than 1 MB.

Within the descriptions of the figures, similar elements are provided similar names and reference numerals as those of the previous figure(s). Where a later figure utilizes the element in a different context or with different functionality, the element is provided a different leading numeral representative of the figure number (e.g., 1xx for FIG. 1 and 2xx for FIG. 2). The specific numerals assigned to the elements are provided solely to aid in the description and not meant to imply any limitations (structural or functional) on the invention.

With reference now to FIG. 2, there is depicted a high level block diagram of the components within indexing device 150 of book 100, according to an embodiment of the present invention. Indexing device 150 includes processor unit 200, which utilizes GUI 210 to facilitate the input of search criteria and to display output data produced by search utility 205. In one embodiment, search utility 205 is a program within memory device 120. In another embodiment, search utility 205 may be firmware within processor unit 200.

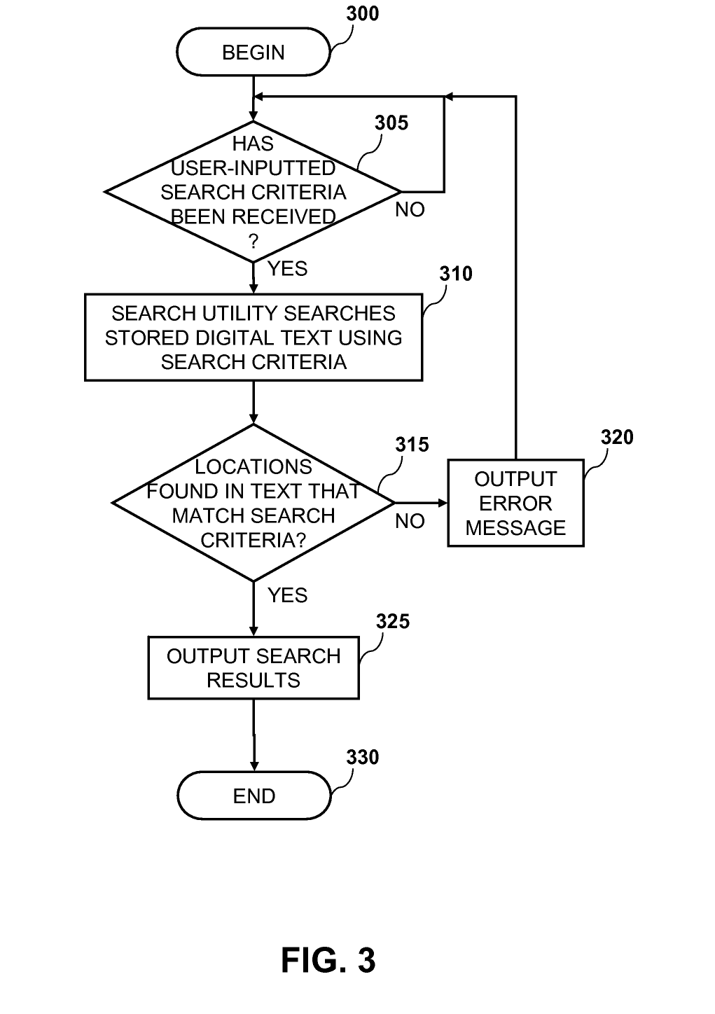

According to the illustrative embodiment, text 204 of book 100 is stored within memory device 120 as digital text. Search utility 205 is POSIX compliant, where POSIX refers to a Portable Operating System Interface for a uniplexed information and computing (UNIX®) system. Search utility 205 utilizes a POSIX compliant application programming interface (API) to locate data in response to queries from a user of book 100. A user of search utility 205 can thus enter POSIX regular expressions (i.e. combinations of words and/or logical expressions) to perform advanced searches and thereby efficiently locate text 104 within book 100. The search process is illustrated in FIG. 3, which is discussed below. In an alternate embodiment, text 204 of book 100 is indexed and stored in a database (e.g., International Business Machines' (IBM) Cloudscape™ database) within memory device 120. In such an embodiment, search utility 205 utilizes a structured query language (SQL) to locate data in response to queries from a user of book 100.

Turning now to FIG. 3, there is illustrated a high level logical flowchart of an exemplary method of utilizing an electronic embedded book index to search for specific text within a book, in accordance with one embodiment of the invention. The process begins at block 300 in response to a user of book 100 opening the back cover of book 100 or enabling power cells 105 to provide power to the electronic embedded components of indexing device 150 within book 100.

A determination is made whether a user of book 100 has utilized input device 115 to input search criteria, as shown in block 305. The search criteria can include one or more words or a POSIX regular expression. If a user of book 100 has not inputted search criteria, the process returns to block 305 until a user-input of search criteria is received. Once a user has inputted search criteria, search utility 205 searches the digital text stored within memory device 120 for text that matches the search criteria, as depicted in block 310.

A decision is made whether search utility 205 has found one or more locations within the text that match the search criteria, as shown in block 315. If search utility 205 has not found any locations within the text that match to the search criteria, search utility 205 outputs an error message to display 110, as depicted in block 320, and the process returns to block 305.

If search utility 205 has found one or more locations within the text that match the search criteria, search utility 205 outputs the search results to display 110, as shown in block 325, and the process terminates at block 330. In the described embodiment, the search results outputted/displayed in response to queries from a user of book 100 include page numbers and/or offset paragraphs of text excerpts, and the outputted results enable a user to efficiently locate specific information within book 100. The present invention thus enables an electronic index to be physically embedded in book 100 to facilitate searches for information within the specific book 100.

It is understood that the use herein of specific names are for example only and not meant to imply any limitations on the invention. The invention may thus be implemented with different nomenclature/terminology and associated functionality utilized to describe the above devices/utility, etc., without limitation.

While an illustrative embodiment of the present invention has been described in the context of a fully functional computer system with installed software, those skilled in the art will appreciate that the software aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as thumb drives, floppy disks, hard drives, CD ROMs, DVDs, and transmission type media such as digital and analog communication links.

While the invention has been particularly shown and described with reference to a preferred embodiment, it will be understood by those skilled in the art that various changes in form and detail may be made therein without departing from the spirit and scope of the invention.

What is claimed is:

1. In a device that provides an electronic index for a book, a method comprising:
storing digital text of said book in a memory device attached to said book;
when a user of said book inputs search criteria, searching said digital text to determine one or more locations within said book of said search criteria; and
outputting said one or more locations of said search criteria to said user.

2. The method of claim 1, wherein the step of searching said digital text comprises implementing a portable operating system interface for UNIX® (POSIX) compliant search utility to enable said user to perform advanced searches of said digital text by inputting combinations of words and logical expressions.

3. The method of claim 1, wherein the step of storing said digital text further comprises:
assigning values to said text within a database; and
enabling said user to utilize a structured query language (SQL) to search said values within said database to determine the one or more locations of said search criteria.

4. The method of claim 1, wherein said device that provides said electronic index is a standalone device independent of said book, said device having a port for receiving the memory device, and said method further comprising:
enabling said memory device to be inserted into a port of said device, wherein said standalone device is communicatively connected to said memory device;
and accessing said memory device to retrieve the one or more locations.

5. The method of claim 1, wherein said outputting said one or more locations of said search criteria further comprises outputting page numbers within said book at which said criteria is located.

6. The method of claim 1, wherein said one or more locations of said search criteria further comprises one or more of: paragraphs and line numbers of text excerpts within said book.

7. The method of claim 1, wherein the device is embedded within a cover of said book and the memory device is communicatively connected to the physical device.

8. The method of claim 1, wherein the device is physically attached to the book and the memory device is communicatively connected to the physical device.

9. A book comprising:
an electronic index device/system attached to a cover of said book;
a display device attached to said cover;
an input device attached to said cover;
a processor unit attached to said cover;
a memory device attached to said cover that provides means for storing digital text of said book;
means for searching said digital text to determine one or more locations within said book of said search criteria when a user of said book inputs said search criteria; and
means for outputting said one or more locations of said search criteria to said user.

10. The book of claim 9, wherein the electronic index device/system is embedded within a cover of said book and the memory device is communicatively connected to the physical device.

11. The book of claim 9, wherein said means for searching said digital text further comprises means for implementing a portable operating system interface for UNIX® (POSIX) compliant search utility to enable said user to perform advanced searches of said digital text by inputting combinations of words and logical expressions.

12. The book of claim 9, wherein said means for storing said digital text further comprises means for:
assigning values to said text within a database; and
enabling said user to utilize a structured query language (SQL) to search said values within said database to determine the one or more locations of said search criteria.

13. The book of claim 9, further comprising one or more power cells from among: solar cells, batteries, and power supplies providing electrical power.

14. The book of claim 9, wherein said outputting said one or more locations of said search criteria comprises outputting page numbers within said book at which said criteria is located.

15. The book of claim 9, wherein said one or more locations of said search criteria further comprises one or more of: paragraphs and line numbers of text excerpts within said book.

16. A computer program product comprising:
a computer readable medium; and program code on said computer readable medium that that when executed provides the functions of:
storing digital text of said book in a memory device embedded within said book;
when a user of said book inputs search criteria, searching said digital text to determine one or more locations within said book of said search criteria; and
outputting said one or more locations of said search criteria to said user.

17. The computer program product of claim 16, wherein said program code for searching said digital text comprises code for implementing a portable operating system interface for UNIX® (POSIX) compliant search utility to enable said user to perform advanced searches of said digital text by inputting combinations of words and logical expressions.

18. The computer program product of claim 16, wherein said program code for storing said digital text further comprises code for:
assigning values to said text within a database; and
enabling said user to utilize a structured query language (SQL) to search said values within said database to determine the one or more locations of said search criteria.

19. The computer program product of claim 16, wherein said outputting said one or more locations of said search criteria further comprises outputting page numbers within said book at which said criteria is located.

20. The computer program product of claim 16, wherein said one or more locations of said search criteria further comprises one or more of: paragraphs and line numbers of text excerpts within said book.
